(19) United States
(12) Patent Application Publication
(10) Pub. No.: US 2024/0108984 A1
(43) Pub. Date: Apr. 4, 2024

(54) GAME ASSET OPTIMIZATION OVER NETWORK AT OPTIMIZER SERVER

(71) Applicant: Sony Interactive Entertainment Inc., Tokyo (JP)

(72) Inventors: Jeff Stafford, Redwood City, CA (US); Michael Starich, Mission Viejo, CA (US)

(21) Appl. No.: 17/956,404

(22) Filed: Sep. 29, 2022

(51) Int. Cl. A63F 13/57; A63F 13/355

(52) U.S. Cl. CPC A63F 13/57; A63F 13/355

(57) ABSTRACT

A method including receiving from a device over a network at an optimizer server a plurality of game assets of a video game. The method including generating at least one combined game asset to represent the plurality of game assets. The method including sending the at least one combined game asset to the device for use in the video game.

### TECHNICAL FIELD

The present disclosure is related to gaming, and more specifically to cloud based servers optimizing game assets that reduce the amount of resources required for performing rendering, wherein the optimized game assets are generated for use during video game development or for use during execution of a video game.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktops or laptop computers, mobile phones, virtual reality and augmented reality head mounted devices, etc.

A video game is limited in how much rendering assets (e.g., geometry, textures, shaders, etc.) can be drawn during rendering of a scene. As video games and their corresponding game plays become more complex, a scene may include increasing numbers of objects over successive frames that eventually become too expensive and/or burdensome to render. In particular, piles of dynamic geometry (e.g., objects, etc.) or decals (e.g., bullet holes, etc.) can become very expensive to render, and it is impossible to pre-author during video game development all the different combinations of object placements (e.g., objects in a pile or where bullet holes are placed) that are generated during the many game plays of players. For example, in a first person shooter video game a player may have to survive a horde of attacking enemies. With each kill, a corresponding body falls to the ground and as the game play continues bodies are scattered around or piles of bodies may be formed. As the number of kills increases, the number of bodies or objects that need to be rendered in the scene also increases. At some point, the rendering engine is overtaxed and may decide to stop rendering bodies associated with older kills (i.e., fade them out from the scene) while rendering bodies associated with more recent kills. The player is left with a less than realistic gaming experience as the depicted scene may be missing bodies that the player has killed.

It is in this context that embodiments of the disclosure arise.

### SUMMARY

Embodiments of the present disclosure relate to a cloud based game asset optimizer server configured to create new geometry or textures that can be rendered using less resources from game assets that are generated for a video game during development or game play of the video game. In that manner, the new geometry or textures optimized for rendering using less resources can be sent back to the developer for incorporation into the video game as a game asset, or can be sent back to the processing engine for use when executing an instance of the video game to render a scene. For example, during a game play of a video game that generates a pile of zombies or a wall with many bullet holes, the cloud based game asset optimizer server can create new geometry, materials, textures and/or shaders (i.e., as new rendering assets) that are sent back to the processing engine for use when rendering scenes in the game play. These new rendering assets allow the video game to keep executing efficiently without interruption (i.e., maintain high frame rates when generating/rendering video frames) and without having to fade assets out and not render them. Similarly, the optimizer server can be configured to execute material shading, lighting and shadow processes (i.e., as shading processes) that can be used when rendering a scene in a video game. As such, rendering assets and/or the shading processes may be decoupled from the execution of a video game to allow a separate back-end server to independently execute the creation of new rendering assets and/or the shading processes. In some embodiments, the new rendering assets can be used to render scenes having the same or similar objects in other game plays of the same video game.

In one embodiment, a method is disclosed. The method including receiving from a device over a network at an optimizer server a plurality of game assets of a video game. The method including generating at least one combined game asset to represent the plurality of game assets. The method including sending the at least one combined game asset to the device for use in the video game.

In another embodiment, a non-transitory computer-readable medium storing a computer program for implementing a method is disclosed. The computer-readable medium including program instructions for receiving from a device over a network at an optimizer server a plurality of game assets of a video game. The computer-readable medium including program instructions for generating at least one combined game asset to represent the plurality of game assets. The computer-readable medium including program instructions for sending the at least one combined game asset to the device for use in the video game.

In still another embodiment, a computer system is disclosed, wherein the computer system includes a processor and memory coupled to the processor and having stored therein instructions that, if executed by the computer system, cause the computer system to execute a method. The method including receiving from a device over a network at an optimizer server a plurality of game assets of a video game. The method including generating at least one combined game asset to represent the plurality of game assets. The method including sending the at least one combined game asset to the device for use in the video game.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates an example system including a cloud based game asset optimizer server configured to create new game assets that can be rendered using less resources from a plurality of game assets that are created or generated for a video game, in accordance with one embodiment of the present disclosure.

FIG. 2A is a flow diagram illustrating a method for creating new a new game asset from a plurality of game assets that are generated during development or game play of a video game, in accordance with one embodiment of the present disclosure.

FIG. 2B is a flow diagram illustrating a method for creating a combined model from a plurality of models of objects and for creating a modified texture from an original texture and texture decals, in accordance with one embodiment of the present disclosure.

FIGS. 3A-3D illustrate the generation of one or more combined game assets as models from a plurality of objects, wherein the combined game assets are optimized for rendering for a corresponding video game, in accordance with embodiments of the present disclosure.

FIGS. 4A-4B illustrates the generation of a texture and one or more texture decals during execution of an instance of a video game and the generation of a modified texture that includes the original texture and the texture decals by a cloud based game asset optimizer server for use as a game asset in the video game, in accordance with one embodiment of the disclosure.

FIG. 5 illustrates a data flow diagram illustrating the pushing or pulling of game assets to or by a cloud based game asset optimizer server for optimization of those game assets, in accordance with one embodiment of the present disclosure.

FIG. 6 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure described below are set forth without any loss of generality to, and without imposing limitations upon, the claims that follow this description.

Generally speaking, the various embodiments of the present disclosure describe systems and methods providing game asset optimization at a cloud based server. In that manner, new geometry, materials, textures and/or shaders (i.e., as new rendering assets) can be generated that are optimized for rendering original game assets overlaid with new rendering assets to represent cumulated decals and/or a combination (e.g., pile) of rendering assets from a plurality of other game assets. The new rendering assets can be incorporated as a game asset during development of a video game or when executing an instance of a video game. Also, various shading processes (e.g., material shading, lighting, shadowing, etc.) may be performed at the cloud based game asset optimization server. As such, optimization of the rendering assets and/or various shading processes can be decoupled from the execution of a video game through the use of a cloud based game asset optimization server.

Advantages of the methods and systems configured to implement a game asset optimizer server configured to create new rendering assets that are optimized for rendering original game assets overlaid with decals or combined with other game assets, include rendering scenes of a video game at required frame rates without slowing or interruption and without fading of game assets provided in the scene, and include efficient use of memory when rendering a scene. In a simplistic overview of a graphics pipeline used for rendering a three-dimensional scene, objects in the scene are transformed to locations in a world view with reference to a coordinate system. Polygon geometry of the objects are generated to represent the objects in the world view. The scene is rendered through a graphics pipeline that performs multiple shader operations (e.g., applying physics, lighting, etc.) on the polygon geometry from a particular viewpoint, and then applying textures to the surfaces of polygon geometry. The resulting image of the scene that is generated can be streamed over a network or placed into a frame buffer for immediate display. Each of these operations in the graphics pipeline entail the use of memory. As more and more objects are drawn into a scene, additional memory resources are required during the rendering process, and traditional rendering systems would experience slowing or interruptions in frame rate, or fading of artifacts through elimination of game assets during the rendering process, or restricting the number and detail level of asset rendering to maintain a high frame rate. Advantageously, embodiments of the present disclosure decouple optimization of rendering assets from the execution of a video game, to allow cloud based game asset optimization servers to generate new rendering assets as new game assets that can be incorporated into a video game during development or used when executing a video game. In that manner, the new rendering assets that are rendered using less resources can be used to represent original game assets overlaid with decals or combined with other game assets at required frame rates without slowing or interruption and without fading of game assets provided in the scene, wherein the original game assets would overload the rendering process. As another advantage, the new rendering assets optimized for rendering require less memory during the rendering process. In that manner, increasingly detailed scenes can be rendered that include more and more objects and/or overlaid with decals, wherein multiple stages of optimization of game assets at a cloud based server can be implemented to accommodate for the increasing detail of the scene (e.g., increasing numbers of game assets added to the scene) during rendering.

Throughout the specification, the reference to “game” or video game” or “gaming application” is meant to represent any type of interactive application that is directed through execution of input commands. For illustration purposes only, an interactive application includes applications for gaming, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Further, the terms introduced above are interchangeable.

With the above general understanding of the various embodiments, example details of the embodiments will now be described with reference to the various drawings.

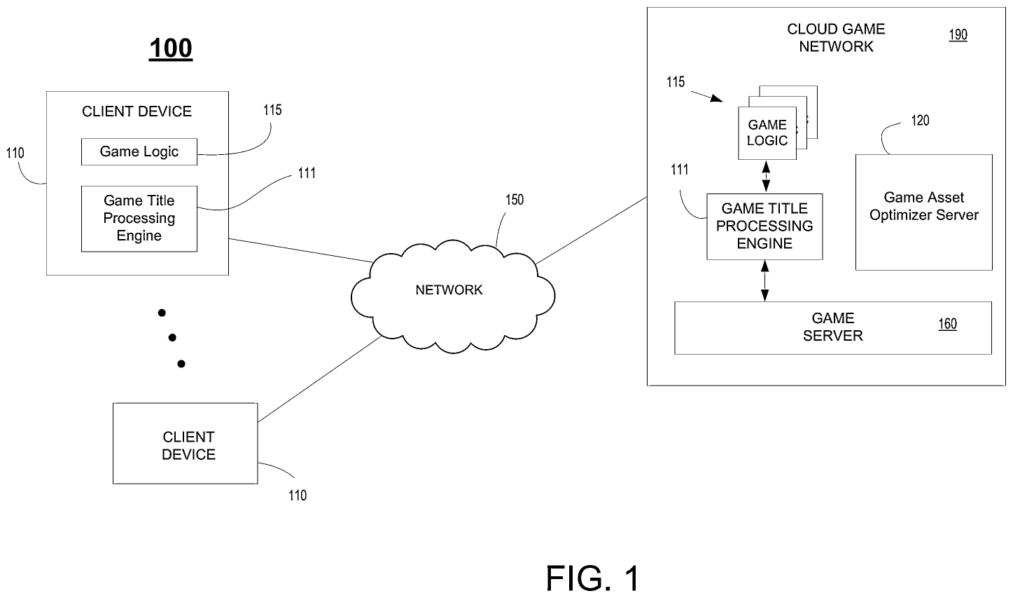

FIG. 1 illustrates an example system 100 including a game asset optimizer server 120 configured to create new rendering assets that are optimized for rendering a scene of a video game, wherein the new rendering assets represent the original rendering assets overlaid with decals and/or are combined with other rendering assets from other game assets. Also, the game asset optimizer server may be configured to execute material shading, lighting, and shadow processes (i.e., as shading processes) that can be used when rendering a scene in a video game. The game asset optimizer server 120 may be utilized to create new rendering assets and/or new shading processes during development of a video game, or during game play of the video game.

As shown, system 100 may provide gaming over a network 150 for and between one or more client devices 110 for single-player or multi-player gaming. For example, system 100 may be configured to provide gaming to users participating in a single-player or multi-player gaming session via a cloud game network 190, wherein the game can be executed locally (e.g., on a local client device of a corresponding user for online gaming) or can be executed remotely from a corresponding client device 110 (e.g., acting as a thin client for cloud based streaming) of a corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world, managing communications between user, etc. so that the users in distributed locations participating in a multi-player gaming session can interact with each other in the gaming world or metaverse in real-time.

Although system 100 illustrates the use of the game asset optimizer server 120 during online gaming (e.g., local processing of a video game) or streaming (e.g., cloud based processing of a video game), the game asset optimizer server 120 may be utilized to optimize game assets during the development of a video game. For example, a developer that is creating game assets for the video game may be utilizing client device 110 shown in FIG. 1, or a different device that is configured to send optimization requests directly or indirectly to the game asset optimizer server 120. In that manner, the creation and/or generation of game assets to be included within the video game may be performed by a cloud based service provided by the game asset optimizer server 120.

In particular, system 100 may provide gaming control to one or more users playing one or more applications (e.g., video games) either through local instances operating on client devices or through cloud based instances operating in the cloud game network 190 via network 150 in the multi-player session. Network 150 may include one or more communication technologies, including 5^{th} Generation (5G) network technology having advanced wireless communication systems (e.g., cellular network technology). In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session allowing participation for a group of users to interact within a gaming world generated by an application (which may be a video game), some users may be executing an instance of the application locally on a client device to participate in the multi-player session. Other users who do not have the application installed on a selected device or when the selected device is not computationally powerful enough to execute the application may be participating in the multi-player session via a cloud based instance of the application executing at the cloud game network 190.

As shown, the cloud game network 190 includes a game server 160 that provides access to a plurality of video games for single-player or multi-player gaming. Most applications played in a corresponding multi-player session are played over the network 150 with connection to the game server 160. For example, in a multi-player session involving multiple instances of an application (e.g., generating virtual environment, gaming world, metaverse, etc.), a dedicated server application (session manager) collects data from users and distributes it to other users so that all instances are updated as to objects, characters, etc. to allow for real-time interaction within the virtual environment of the multi-player session, wherein the users may be executing local instances (e.g., online gaming) or cloud based instances (e.g., cloud based streaming) of the corresponding application. Game server 160 may be any type of server computing device available in the cloud, and may be configured as one or more virtual machines executing on one or more hosts. For example, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. In that manner, a computationally complex gaming application may be executing at the back-end server in response to controller inputs received and forwarded by client device 110. Each server is able to render images and/or frames that are then encoded (e.g., compressed) and streamed to the corresponding client device for display.

In the multi-player session, instances of an application may be executing locally on a client device 110 or at the cloud game network 190. In either case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication channels, audio communication, texting, messaging, instant messaging, chat support, game play replay functions, help functions, etc.

Users access the remote services with client devices 110, which include at least a CPU, a display and input/output (I/O). For example, users may access cloud game network 190 via communications network 150 using corresponding client devices 110 configured for updating a session controller (e.g., delivering and/or receiving user game state data), receiving streaming media, etc. The client device 110 can be a personal computer (PC), a mobile phone, a netbook, a personal digital assistant (PAD), handheld device, head mounted device, etc.

In one embodiment, client device 110 may be configured with a game title processing engine and game logic for at least some local processing of an application, and may be further utilized for receiving streaming content as generated by the application executing at a back-end server, or for other content provided by back-end server support. In still other embodiments, for independent local processing the game title processing engine 111 includes basic processor based functions for executing an application and services associated with the application, as previously described. For local processing, the game logic 115 is stored on the local client device 110 and is used for executing the application. For example, an instance of an application is executing by the game title processing engine 111 of a corresponding client device 110. Game logic 115 (e.g., executable code) implementing the application is stored on the corresponding client device 110, and is used to execute the application. For purposes of illustration, game logic 115 may be delivered to the corresponding client device 110 through a portable medium (e.g. optical media) or through a network (e.g., downloaded through the internet from a gaming provider).

In one embodiment, client device 110 may be configured as a thin client providing interfacing with a back end server (e.g., game server 160 of cloud game network 190) configured for providing computational functionality (e.g., including game title processing engine 111). In particular, client device 110 of a corresponding user (not shown) is configured for requesting access to applications over a communications network 150, such as the internet, and for rendering for display images generated by a video game executed by the game server 160, wherein encoded images are delivered (i.e., streamed) to the client device 110 for display in association with the corresponding user. For example, the user may be interacting through client device 110 with an instance of an application executing on a game processor of game server 160 in association with gameplay of a corresponding user, such as through input commands that are used to drive the gameplay. Client device 110 may receive input from various types of input devices, such as game controllers, tablet computers, keyboards, gestures captured by video cameras, mice, touch pads, audio input, etc. More particularly, an instance of the application is executed by the game title processing engine 111 and is configured for generating rendered images, which is delivered over network 150 for display at a corresponding display in association with client device 110. That is, client device 110 is configured for receiving encoded images (e.g., encoded from game rendered images generated through execution of a video game), and for displaying the images that are rendered for display. Game title processing engine 111 is able to support a plurality of applications using a plurality of game logics, each of which is selectable by the user.

In addition, system 100 includes a game asset optimizer server 120 configured to create new geometry, materials, textures and/or shaders (i.e., as new rendering assets) that are optimized for rendering a scene of a video game, wherein the new rendering assets represent original game assets overlaid with decals and/or are combined with other game assets. Also, the game asset optimizer server 120 may be configured to execute material shading, lighting, and shadow processes (i.e., as shading processes) that can be used when rendering a scene in a video game. Game asset optimizer server 120 may be located at the cloud game network 190 or may be remote from the cloud game network 190. In one implementation, the optimization of game assets can be performed at a cloud based server as a service that generates the new rendering assets and/or performs shading processes for incorporation as a new game asset during development of the video game. In another implementation, the optimization of game assets can be performed at a cloud based server to decouple the optimization process from execution of the video game. In that manner, while a player is playing a video game, game assets that are generated during game play can be optimized using a process at the cloud based server to create new rendering assets that can be used at a later point during the game play when re-rendering a corresponding scene. For example, the optimization of game assets can be performed during periods of the game play where the scene or a corresponding viewpoint of the scene is not currently being rendered, such as when the player is taking a break in the game play, or has moved away from a location in the scene (i.e., gone to another place in the gaming world, gone to another level, etc.), or has turned away from a viewpoint that includes the game assets to be optimized (e.g., turned away from a pile of objects that can be optimized for later rendering in the scene when the player turns back to the viewpoint including the pile of objects).

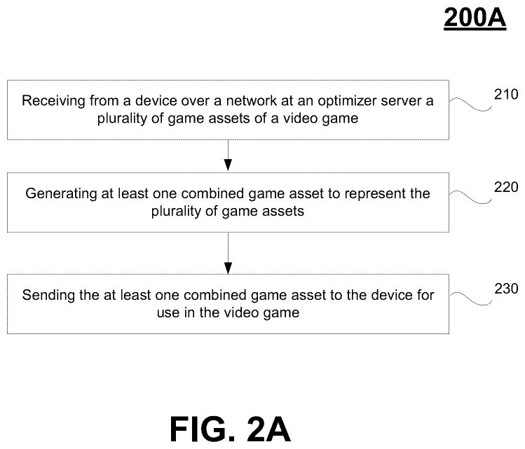

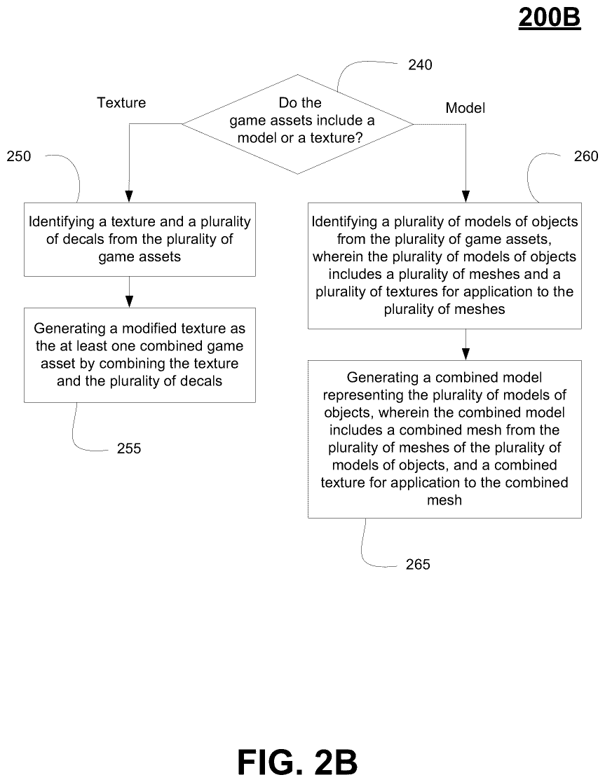

With the detailed description of the system 100 of FIG. 1, flow diagram 200A of FIG. 2A discloses a method providing for the generation of new game assets that are optimized for rendering, wherein new rendering assets represent original game assets overlaid with decals and/or are combined with other game assets generated for a video game during development or during game play. The operations performed in the flow diagram may be implemented by one or more of the components of system 100 previously described in FIG. 1, including game asset optimizer server 120.

At 210, the method includes receiving from a device over a network at an optimizer server a plurality of game assets of a video game. The game assets may include geometry, such as polygons forming meshes of one or more objects. For example, during game play of video game similar objects may be continually generated in a scene, such as during a never ending zombie attack when a player is killing zombies requiring the rendering of more and more dead zombies (e.g., scattered about or in one or more piles). In addition, the game assets may include textures that are overlaid with texture decals. For example, a wall object having a texture may be overlaid with countless gunshot decals representing bullet holes as a player continually fires a gun in a direction towards the wall. These game assets may be optimized for rendering.

At 220, the method includes generating at least one combined game asset to represent the plurality of game assets. In particular, a combined game asset may combine geometry from a plurality of game objects into a single mesh including reduced polygon geometry that represents the game objects. In that manner, the mesh representing the plurality of game objects can be rendered more efficiently than rendering each individual object in the plurality of objects. Also, a combined game asset may combine a texture and one or more decals into a single texture. For example, the texture may be placed on a wall object and overlaid with numerous texture overlays (e.g., decals) of bullet holes. In that manner, a modified texture is generated as the combined game asset that combines and/or represents the original texture that is overlaid with the texture overlays. As such, instead of rendering the original texture and each of the texture overlays to be placed on the wall, only the modified texture needs to be placed on the wall during rendering. This process may be repeated to add more geometry and/or more decals to an existing game asset (e.g., original asset or modified asset). It should be noted, that other types of game assets can be generated and combined. For example, other newly generated game assets may include materials, collision boundary meshes, shaders, physics metadata, lighting data, 3D audio emitter data, haptic emitter data, etc. The generation of the at least one combined game asset is described more fully in relation to FIG. 2B below.

At 230 in FIG. 2A, the method includes sending the at least one combined game asset to the device for use in the video game, such as during development or during game play. As previously described, the generation of the at least one combined game asset may be performed at a cloud based game asset optimizer server. For example, the game asset optimizer server may be tasked to generate new game assets by combining many other game assets during the development of a video game. As such, the newly generated game assets may be provided as additional game assets for the video game. That is, the game developer may package up the original game asset with other game assets (decals, other objects, etc.) and send them to the game asset optimizer server providing a service in a request (e.g., bake request) to generate the new game assets (e.g., with modified textures) that can be utilized as new game assets for the video game (i.e., baked into the video game). In addition, the game asset optimizer server may be tasked, in a process independent of execution of the video game during game play, to generate new game assets from original game assets combined with other game assets that are generated during game play of a corresponding video game. For example, the video game may push the game assets to the game asset optimizer server for optimization, or the game asset optimizer server may pull the game assets from the executing video game for optimization. In that manner, the new game asset (e.g., with modified textures) can be utilized at a later time during execution of the video game.

FIG. 2B is a flow diagram 200B illustrating a method for creating a combined model from a plurality of models of objects and for creating a modified texture from an original texture and texture decals, in accordance with one embodiment of the present disclosure. In particular, flow diagram 200B provides more detail to the generation of the at least one combined game asset performed at 220 of FIG. 2A.

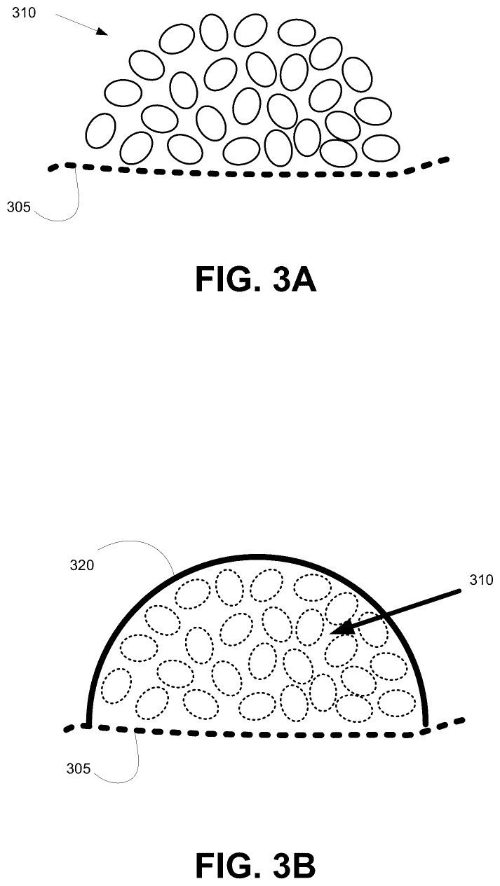

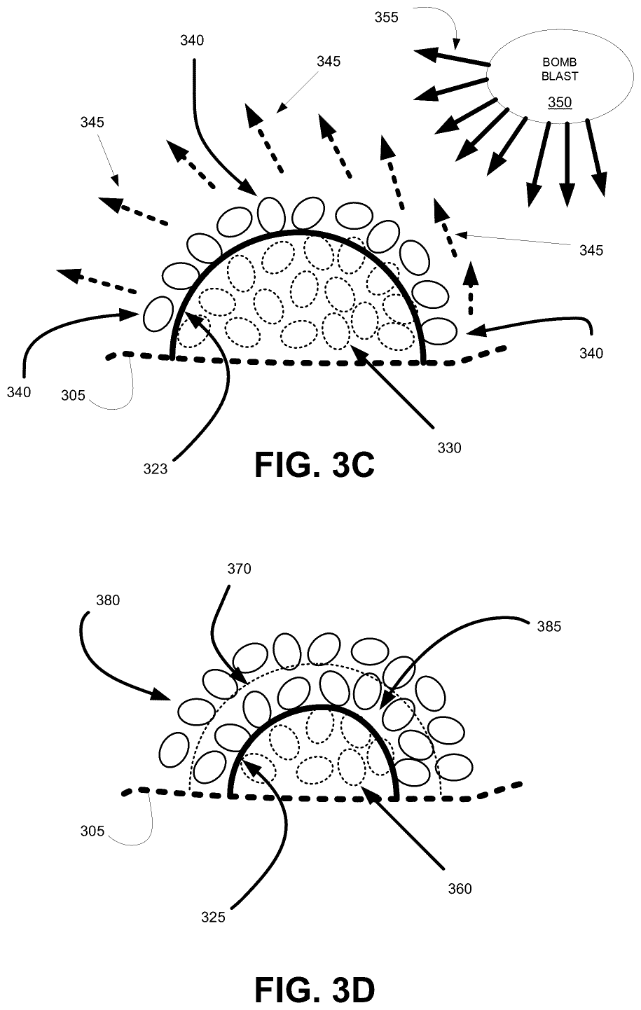

At decision step 240, it is determined whether the plurality of game assets to be combined include a model with geometry or a texture. If there are models of geometry to be combined, operations 260 and 265 are performed. In particular, at 260 a plurality of models of objects are identified from the plurality of game assets. Each of the models includes a corresponding mesh with corresponding textures applied to the mesh (e.g., surface of mesh). It should be noted that many other forms of model data (materials, shaders, collision boundary meshes, etc.) could be included for purposes of generating a combined model, but for this example, geometry meshes and their associated textures are used for generating the combined model. The plurality of models of objects includes a plurality of meshes and a plurality of textures for application to the plurality of meshes. In addition, at 265 a combined model representing the plurality of models of objects is generated. In particular, the combined model includes a combined mesh that is generated from the plurality of meshes of the plurality of models of objects. The combined mesh represents the plurality of models of objects and is optimized for rendering. In general, the combined mesh can be optimized by decimating visible geometry and associated assets to reduce polygon count, textures, shaders, etc. For example, the optimization of the combined meshes into a single mesh for rendering could include removing unseen geometry and their associated assets including textures, materials, shaders, etc. (that is geometry that would be hidden by other geometry), reducing the number of polygons in the visible geometry (i.e., decimating visible geometry), etc. Also, a combined texture (e.g., an Atlas texture) may be generated for application to the combined mesh, wherein the combined texture may be based on the textures (e.g., decimating textures to reduce many textures to fewer textures or to one texture, or generating an Atlas texture from many textures, etc.) that are applied to the individual plurality of meshes. For example, FIGS. 3A-3D illustrate various combined models in embodiments of the present disclosure.

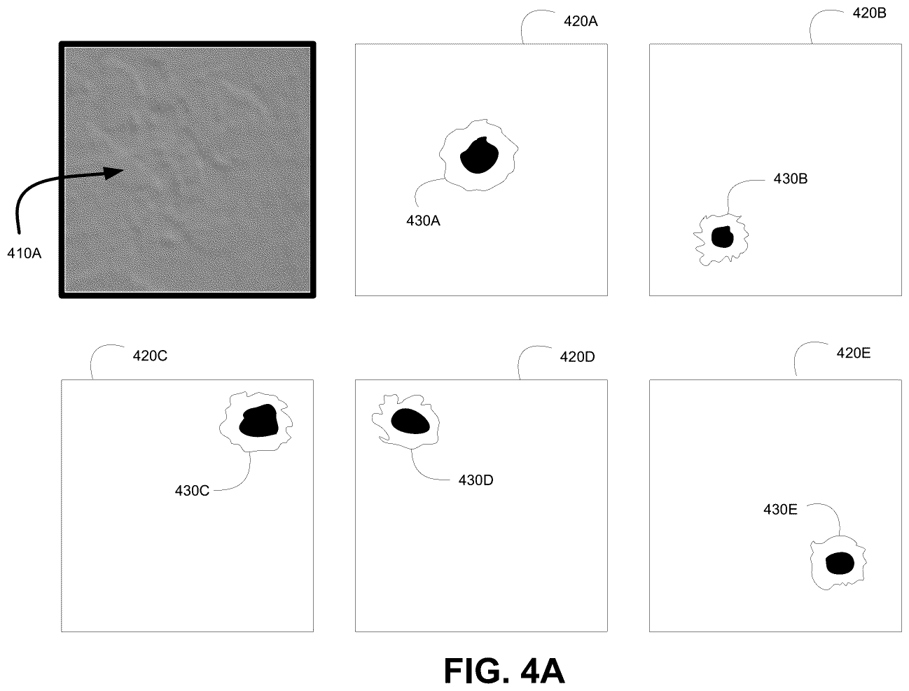

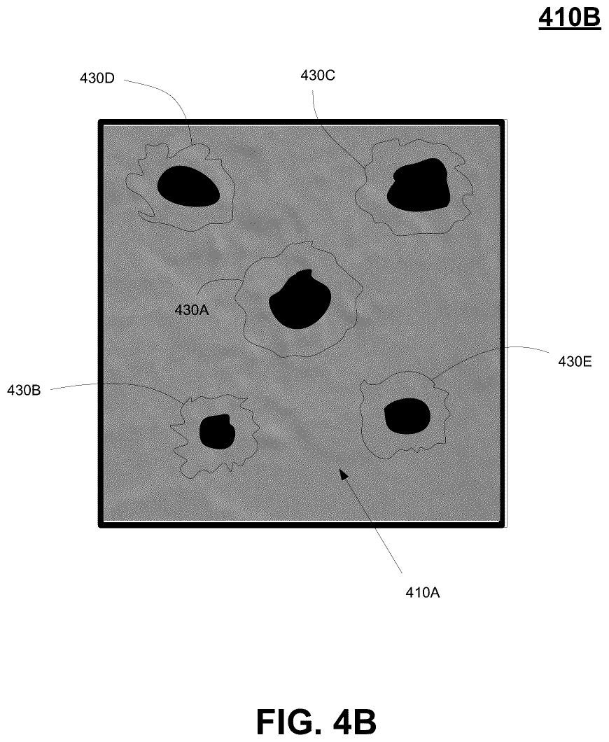

On the other hand, when it is determined at 240 in FIG. 2B that there are textures and texture decals to be combined, then operations 250 and 255 are performed. In particular, at 250 an original texture and a plurality of decals are identified from the plurality of game assets. For example, the original texture may be applied to a mesh of an object (e.g., a wall object), and the plurality of decals may be bullet holes that are continuously generated by a video game and overlaid onto the texture. In addition, at 255 a modified texture is generated (i.e., as the at least one combined game asset), wherein the modified texture is generated by combining the original texture and the plurality of texture decals. For example, FIGS. 4A-4B illustrate the generation of a modified texture including an original texture and bullet holes as texture decals.

FIGS. 3A-3D illustrate the generation of one or more combined game assets as models from a plurality of objects, wherein the combined game assets are optimized for rendering for a corresponding video game, in accordance with embodiments of the present disclosure. In particular and for purposes of illustration only to show the optimization of game assets, FIG. 3A illustrates a plurality of objects 310, wherein the objects are generated during execution of an instance of a video game or created as one or more game assets during development of the video game, in accordance with one embodiment of the present disclosure. Each of the plurality of objects 310 may be considered as a game asset for the corresponding video game. Each of the objects in the pile 310 may be represented by a corresponding model that includes a corresponding mesh (e.g., polygon geometries), corresponding texture applied to the corresponding mesh, and corresponding orientation within a coordinate system for the corresponding scene. Additional information may be generated for each of the objects. For example, the plurality of objects 310 may be arranged in a pile that is located on a supporting surface 305. Before optimization by the game asset optimizer server, each of the plurality of objects 310 is a discrete object that is handled independently through a graphics pipeline, such that each of the objects is rendered independently.

FIG. 3B illustrates the generation of a mesh as a combined game asset by a cloud based game asset optimizer server that can be rendered to represent the plurality of objects 310 introduced in FIG. 3A, in accordance with one embodiment of the present disclosure. In particular, the combined game asset combines geometry from the plurality of objects 310 into a single mesh 320 that includes reduced polygon geometry. For example, the combined mesh 320 is generated based on the meshes of the plurality of objects 310. The combined mesh 320 is optimized for rendering and represents the plurality of objects 310, or at least a viewable portion of the plurality of objects 310. For example, the mesh 320 may represent the outer surface of the pile of objects. In that manner, the combined mesh 320 need only be rendered for a scene instead of separately rendering each of the plurality of objects 310. Also, a combined texture may be generated for application to the combined mesh, wherein the combined texture may be based on the textures that are applied to the individual meshes of the plurality of objects 310. In particular, each of the plurality of objects 310 is represented by a dotted outline to illustrate how the mesh 320 is rendered through the graphics pipeline, instead of individually rendering each of the plurality of objects 310. That is, shader operations such as physics and lighting are performed on the mesh 320 instead of each of the plurality of objects 310.

FIG. 3C illustrates the generation of multiple combined game assets that are optimized for rendering. For example, one or more combined game assets optimized for rendering are created to represent the plurality of objects 310 introduced in FIG. 3A. Each of the plurality of objects 310 located on supporting surface 305 may be a discrete object that is a game asset for a video game. The plurality of objects 310 includes a plurality of meshes and a plurality of textures applied to the meshes. For example, each of the plurality of objects 310 includes a corresponding mesh and corresponding texture applied to the mesh.

More particularly, an outer shell 340 of dynamic objects is defined. The outer shell 340 includes a first sub-group of discrete objects taken from the plurality of objects 310 located within a scene. The first sub-group of discrete objects may be defined based on a collision based interaction radius. For purposes of illustration, the first sub-group of discrete objects may be defined by a blast radius (i.e., the collision based interaction radius associated with an interaction of some force) associated with an explosion or a bomb blast 350 of a bomb applying a plurality of forces 355, wherein objects in the first sub-group are affected by the bomb blast 350. Other criteria may be used to define the first set-up-group of discrete objects. Each of the discrete objects in the first sub-group is dynamically rendered by the video game using corresponding meshes and textures. For example, the discrete objects in the outer shell 340 may individually be rendered through the graphics pipeline and shown flying away from the pile of objects in different directions 345.

An inner core 330 of objects include a second sub-group of discrete objects which includes remaining objects in the plurality of objects 310 that are not in the first sub-group of discrete objects. Objects in the inner core 330 are outside of the collision based interaction radius (e.g., are not affected by the bomb blast, such that these objects are outside of the blast radius). A combined game asset that is a combined mesh 323 is generated from the meshes corresponding to the discrete objects in the inner core 330, wherein the mesh 323 can be rendered to represent the inner core 330 of objects. In particular, the combined mesh 323 is generated based on the geometry from the objects in the inner core 330, wherein the combined mesh 323 includes reduced geometry when compared to the geometry from the objects in the inner core 330. The combined mesh 323 is optimized for rendering and represents the objects in the inner core 330, or at least a viewable portion of those objects, such as an outer surface of the inner core 330 of objects. In that manner, the combined mesh 323 need only be rendered for a scene instead of separately rendering each of the objects in the inner core 330. Also, a combined texture may be generated for application to the combined mesh 323, wherein the combined texture may be based on the textures that are applied to the individual meshes of the objects in the inner core 330.

FIG. 3D illustrates the generation of multiple combined game assets that are optimized for rendering including the designation of one or more layers of dynamic objects taken from the plurality of objects 310 introduced in FIG. 3A, and the generation of a mesh by a cloud based game asset optimizer server that can be rendered to represent an inner core of objects from the pile of objects, in accordance with one embodiment of the present disclosure. As previously described, each of the plurality of objects 310 located on supporting surface 305 may be a discrete object that is a game asset for a video game. The plurality of objects 310 includes a plurality of meshes and a plurality of textures applied to the meshes. For example, each of the plurality of objects 310 includes a corresponding mesh and corresponding texture applied to the mesh.

As shown, a first layer 380 of the plurality of discrete objects 310 may be defined. The first layer 380 includes a first sub-group of discrete objects, wherein each of the discrete objects in the first sub-group can be dynamically rendered by the video game using corresponding meshes and textures. For example, the objects in the first layer 380 may be defined by a criteria (e.g., a first collision based interaction radius, or blast radius), wherein objects in the first sub-group are affected or defined by the criteria.

In addition, a second layer 385 of the plurality of discrete objects 310 may be defined, wherein objects in the first and second layers may be virtually separated by dotted line 370. The second layer 385 includes a second sub-group of discrete objects, wherein each of the discrete objects in the second sub-group can be dynamically rendered by the video game using corresponding meshes and textures. For example, the objects in the second layer 385 may be defined by a criteria (e.g., a second collision based interaction radius, or a second blast radius), wherein objects in the second sub-group are affected or defined by the criteria. For illustration, the criteria may be the same collision based interaction radius e.g., blast radius) previously introduced, wherein objects in the second layer 385 are defined by the collision based interaction radius (e.g., blast radius) from a second bomb, and are affected after the objects in the first layer 380 are removed by a first bomb. In another case, objects in the first layer 380 and the second layer 385 may be affected by another criteria (e.g., a larger bomb that has a larger collision based interaction radius or blast radius).

An inner core 360 of objects include a third sub-group of discrete objects which includes remaining objects in the plurality of objects 310 that are not in the first or second sub-group of discrete objects. For illustration, objects in the inner core 360 are not affected by the criteria previously defined (e.g., bomb blast, such that these objects are outside of the blast radius). A combined game asset that is a combined mesh 325 is generated from the meshes corresponding to the discrete objects in the inner core 360, wherein the mesh 325 can be rendered to represent the inner core 360 of objects. In particular, the combined mesh 325 is generated based on the geometry from the objects in the inner core 360, wherein the combined mesh 325 includes reduced geometry when compared to the geometry from the objects in the inner core 360. The combined mesh 325 is optimized for rendering and represents the objects in the inner core 360, or at least a viewable portion of those objects, such as an outer surface of the inner core 360 of objects. In that manner, the combined mesh 325 need only be rendered for a scene instead of separately rendering each of the objects in the inner core 360. Also, a combined texture may be generated for application to the combined mesh 325, wherein the combined texture may be based on the textures that are applied to the individual meshes of the objects in the inner core 360.

FIGS. 4A-4B illustrates the generation of a texture and one or more decals during execution of an instance of a video game and the generation of a modified texture that includes the original texture and the decals by a cloud based game asset optimizer server for use as a game asset in the video game, in accordance with one embodiment of the disclosure. For purposes of illustration, original texture 410A is shown, and may be applied to a mesh of an object, such as a wall object. One or more decals may be applied to the original texture 410A. For purposes of illustration, decals may be bullet holes that are generated during a game play of a video game, wherein the decals may be placed over the original texture 410A using overlay technology when rendering the scene. As shown, decals may be applied using overlays 420A-420e, wherein overlay 420A includes decal 430A, overlay 420B includes decal 430B, overlay 420C includes decal 430C, overlay 420D includes decal 430D, and overlay 420E includes decal 430E. Each of the decals 430A-430E represents a different bullet hole. As previously described, a modified texture 410B may be generated that is optimized for rendering, wherein the modified texture includes the original texture 410A and each of the decals 430A-430E previously shown in overlays 420A-420E. In that manner, the modified texture 410B need only be rendered for the scene instead of separately rendering the original texture 410A and each of the decals 430A-430E.

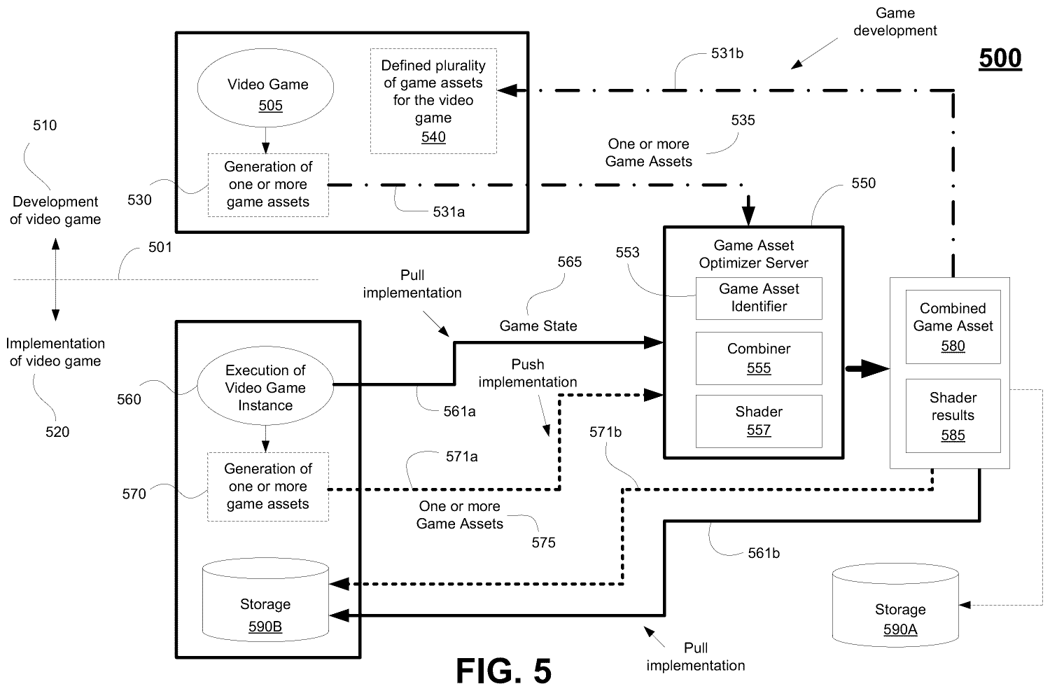

FIG. 5 illustrates a data flow diagram 500 illustrating the pushing or pulling of game assets to or by a cloud based game asset optimizer server for optimization of those game assets, in accordance with one embodiment of the present disclosure. As previously described, optimization of game assets may be performed in at least two different implementations of a video game, as shown by line 501. In particular, operations above line 501 show the development 510 of a corresponding video game 505, and operations below line 501 show the implementation and/or execution 520 of an instance of the video game for a game play.

During development 510 of the video game 505 or during an author time, one or more game assets are generated at 530. For example, game assets can be anything that is used during the execution of the video game to generate a scene, including objects, characters, textures, lighting, special effects, music, etc. The developer may choose to utilize the service provided by the game asset optimizer server for optimization by combining multiple game assets into a combined game asset that is optimized for rendering. The service may be used to generate additional game assets having various levels of detail (i.e., LODs), or for generating a new game asset at the original resolution (i.e., high or higher resolution) that can be rendered more efficiently. In particular, one or more game assets 535 are packaged by the developer and sent to the game asset optimizer server 550 via line 531a. The combiner 555 is configured to generate a combined game asset 580, as previously described, to include the generation of new geometry (e.g., a new mesh) or new texture (including original texture and one or more decals). The combined game asset 580 is returned via line 531b for inclusion into the plurality of game assets 540 (e.g., as an additional game asset) that can be used during execution of the video game 505.

In addition, during execution of an instance of the video game at 560, game assets can be optimized using a push or pull implementation of the game asset optimizer server 550. The instance of the video game may be executed on a local device (e.g., game console) for online gaming, or may be executed on a cloud based server for cloud based streaming. During execution of the instance of the video game, one more game assets are generated at 570, such as during generation of a scene including the one or more game assets. In addition, execution of various shading processes may be optimized through execution at the game asset optimizer server 550 that is independent of execution of the video game instance 560. For example, using a push or pull implementation of the game asset optimizer server 550, it may be determined (i.e., more efficient, offload workload, etc.) that certain shading processes (e.g., processes including material shading, lighting, shadowing, etc.) may be performed by the game asset optimizer server 550. For example, shader 557 of the game asset optimizer server 550 may be configured to perform shading processes with results 585 (e.g., as an additional game asset) used by the instance of the video game during execution. As such, the game asset optimizer server 550 is configured to decouple the generation of new rendering assets and/or the performance of various shading processes from the execution of the video game.

The push implementation of game asset optimization is shown by lines 571a and 571b. In particular, during execution of the instance of the video game by a corresponding engine or processor, one or more game assets 575 are pushed in a request for optimization to the game asset optimizer server 550 via line 571a. In one embodiment, identification of the one or more game assets 575 suitable for optimization may be performed by the executing engine using artificial intelligence (AI) using an AI model that is configured to determine and/or predict which game assets can be combined for optimization. As such, the AI model can be executing using game state of a game play of the video game to identify the game assets suitable for optimization, wherein those game assets are then pushed to the game asset optimizer server 550 for optimization. In one embodiment, the one or more game assets 575 are provided in the request using a JavaScript Object Notation (JSON) file, or using any format suitable for delivering game asset information. As shown, the combiner 555 feature in the game asset optimizer server 550 is configured to generate a combined game asset 580 from the one more game assets 575, as previously described, such as new geometry (e.g., a new mesh) or new texture (including original texture and one or more texture decals). The combined game asset 580 is returned via line 571b to the engine executing the video game and stored in storage 590B for later access by the video game when rendering a corresponding scene. In addition, the combined game asset 580 can be stored in storage 590A in the cloud for possible use by other game plays of the video game. In particular, the combined game asset 580 can be used by another device executing another instance of the video game when rendering similar game assets.

The pull method of game asset optimization is shown by lines 561a and 561b. In particular, during execution of the instance of the video game by a corresponding engine or processor, game state 565 of the game play is continually sent to the game asset optimizer server 550 via line 561a. The game asset identifier 553 is configured analyze the game state 565 to identify possible game assets suitable for optimization. In one embodiment, identification of the one or more game assets suitable for optimization may be performed by the executing engine using AI, such as via an AI model that is configured to determine and/or predict which game assets can be combined for optimization. The combiner 555 feature in the game asset optimizer server 550 is configured to generate a combined game asset 580 from the one more game assets that are identified using the game asset identifier 553, such as new geometry (e.g., a new mesh) or new texture (including original texture and one or more decals). The combined game asset 580 is returned via line 561b to the engine executing the video game and stored in storage 590B for later access by the video game when rendering a corresponding scene. In addition, the combined game asset 580 can be stored in storage 590A in the cloud for possible use by other game plays of the video game. In particular, the combined game asset 580 can be used by another device executing another instance of the video game when rendering similar game assets.

In one embodiment, the game asset optimizer server may be configured to perform optimization of lighting. For example, performing lighting that is dynamic when generating a scene can become quite expensive when performing rendering. The game asset optimizer server may perform the lighting processes in an off-line process, and bake the results from the pre-computed lighting back into the video game. For example, light meshes may be created by the game asset optimizer that can be later used by the video game when performing lighting in order to render a scene.

In still another embodiment, the game asset optimizer server may be configured to perform refinement of game assets. In particular, video games may have low resolution textures that are applied to static objects that are used to develop a background for a scene. The developer may not have enough time or resources to generate a texture with high resolution that is used in the game. In that case, the game asset optimizer server may be configured to modify the original texture and generate a modified texture having high resolution. For instance, various techniques may be implemented to generate the high resolution, including super-sampling or up-sampling original texture, etc. In that manner, presentation of the graphics for those objects can be improved by applying higher resolution textures to those objects, wherein the higher resolution textures are generated with the game asset optimizer server.

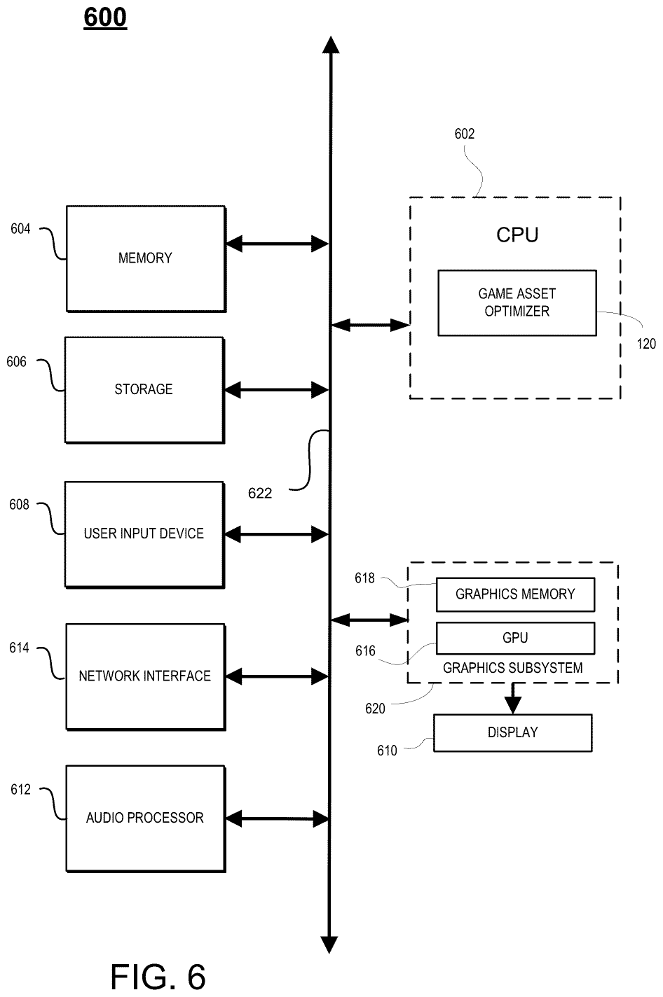

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients, or for implementing additional services such as a supervisor functionality.

In particular, CPU 602 may be configured to implement cloud based game asset optimizer 120 with functionality configured to create new geometry or textures optimized for rendering original geometry and/or textures overlaid with decals. In that manner, use of the cloud based game asset optimizer 120 allows for decoupling of the optimization of geometry and/or textures from the execution of a video game. As such, the video game can be executed normally, while in the background or in an off-line process game asset optimization can be performed using the game asset optimizer. The optimized game assets can be used at a later point when executing the video game to render a scene by rendering the optimized game asset or assets, instead of rendering separately the original geometry and/or textures overlaid with decals

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the Internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 616, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs. In one embodiment, GPU 616 may be implemented within an AI engine (e.g., machine learning engine 190) to provide additional processing power, such as for the AI, machine learning functionality, or deep learning functionality, etc.

The graphics subsystem 620 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

In other embodiments, the graphics subsystem 620 includes multiple GPU devices, which are combined to perform graphics processing for a single application that is executing on a corresponding CPU. For example, the multiple GPUs can perform alternate forms of frame rendering, wherein GPU 1 renders a first frame, and GPU 2 renders a second frame, in sequential frame periods, and so on until reaching the last GPU whereupon the initial GPU renders the next video frame (e.g., if there are only two GPUs, then GPU 1 renders the third frame). That is the GPUs rotate when rendering frames. The rendering operations can overlap, wherein GPU 2 may begin rendering the second frame before GPU 1 finishes rendering the first frame. In another implementation, the multiple GPU devices can be assigned different shader operations in the rendering and/or graphics pipeline. A master GPU is performing main rendering and compositing. For example, in a group including three GPUs, master GPU 1 could perform the main rendering (e.g., a first shader operation) and compositing of outputs from slave GPU 2 and slave GPU 3, wherein slave GPU 2 could perform a second shader (e.g., fluid effects, such as a river) operation, the slave GPU 3 could perform a third shader (e.g., particle smoke) operation, wherein master GPU 1 composites the results from each of GPU 1, GPU 2, and GPU 3. In that manner, different GPUs can be assigned to perform different shader operations (e.g., flag waving, wind, smoke generation, fire, etc.) to render a video frame. In still another embodiment, each of the three GPUs could be assigned to different objects and/or parts of a scene corresponding to a video frame. In the above embodiments and implementations, these operations could be performed in the same frame period (simultaneously in parallel), or in different frame periods (sequentially in parallel).

Accordingly, in various embodiments the present disclosure describes systems and methods configured for creating new geometry and/or textures that are optimized for rendering from original geometry and/or textures that are overlaid with texture decals. The new geometry and/or textures can be incorporated into the corresponding video game during development or used when executing a video game for game play.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

Access to the cloud gaming network by the client device may be achieved through a communication network implementing one or more communication technologies. In some embodiments, the network may include 5^{th} Generation (5G) network technology having advanced wireless communication systems. 5G is the fifth generation of cellular network technology. The 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g., tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein that form part of embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
receiving from a device over a network at an optimizer server a plurality of game assets of a video game;
generating at least one combined game asset to represent the plurality of game assets; and
sending the at least one combined game asset to the device for use in the video game.

2. The method of claim 1, wherein the generating at least one combined game asset includes:
identifying a texture and a plurality of decals from the plurality of game assets; and
generating a modified texture as the at least one combined game asset by combining the texture and the plurality of decals.

3. The method of claim 1, wherein the generating at least one combined game asset includes:
identifying a plurality of models of objects from the plurality of game assets, wherein the plurality of models of objects includes a plurality of meshes and a plurality of textures for application to the plurality of meshes; and
generating a combined model representing the plurality of models of objects, wherein the combined model includes a combined mesh from the plurality of meshes of the plurality of models of objects, and a combined texture for application to the combined mesh.

4. The method of claim 3, further comprising:
optimizing the combined mesh by removing non-visible geometry and associated assets, and decimating visible geometry to reduce polygon counts.

5. The method of claim 3, further comprising:
generating the combined texture by decimating a plurality of textures of the plurality of models of objects; and
applying the combined texture to the combined mesh.

6. The method of claim 1, wherein the generating at least one combined game asset includes:
identifying a plurality of discrete objects from the plurality of game assets, wherein the plurality of discrete objects includes a plurality of meshes and a plurality of textures for application to the plurality of meshes;
defining an outer shell of the plurality of discrete objects, wherein the outer shell includes a first sub-group of discrete objects taken from the plurality of discrete objects, wherein each of the discrete objects in the first sub-group of discrete objects is dynamically rendered by the video game using corresponding meshes and textures;
defining an inner core of the plurality of discrete objects, wherein the inner core includes a second sub-group of discrete objects taken from the plurality of discrete objects,
generating a combined mesh from meshes corresponding to the second sub-group of discrete objects, wherein the combined mesh is used to represent the inner core; and
generating a combined texture from textures corresponding to the second sub-group of discrete objects for application to the combined mesh.

7. The method of claim 6, further comprising:
determining the first sub-group of discrete objects in the outer shell based on an interaction occurring within a scene including the plurality of discrete objects within the video game.

8. The method of claim 1, wherein the generating at least one combined game asset includes:
identifying a plurality of discrete objects from the plurality of game assets, wherein the plurality of discrete objects includes a plurality of meshes and a plurality of textures for application to the plurality of meshes;
defining a first layer of the plurality of discrete objects, wherein the first layer includes a first sub-group of discrete objects taken from the plurality of discrete objects, wherein each of the discrete objects in the first sub-group of discrete objects is dynamically rendered by the video game using corresponding meshes and textures;
defining a second layer of a second sub-group of discrete objects taken from the plurality of discrete objects, wherein each of the discrete objects in the second sub-group of discrete objects is dynamically rendered by the video game using corresponding meshes and textures;
defining an inner core including a third sub-group of discrete objects taken from the plurality of discrete objects;
generating a combined mesh from meshes corresponding to the third sub-group of discrete objects, wherein the combined mesh is used to represent the inner core; and
generating a combined texture from textures corresponding to the third sub-group of discrete objects for application to the combined mesh.

9. The method of claim 1, further comprising:
executing an instance of the video game;
generating a scene including the plurality of game assets;
sending each of the plurality of game assets to the optimizer server;
receiving the at least one combined game asset;
storing the at least one combined game asset in storage;
accessing the at least one combined game asset from the storage; and
rendering the scene using the at least one combined game asset to represent the plurality of game assets.

10. The method of claim 1, further comprising:
wherein the plurality of game assets is built by developers during development of the video game,
wherein the at least one combined game asset is defined as an additional game asset during the development of the video game.

11. The method of claim 1, further comprising:
storing the at least one combined game asset; and
sending the at least one combined game asset to another device for use as a game asset when executing an instance of the video game.

12. A non-transitory computer-readable medium storing a computer program for performing a method, the computer-readable medium comprising:
program instructions for receiving from a device over a network at an optimizer server a plurality of game assets of a video game;
program instructions for generating at least one combined game asset to represent the plurality of game assets; and
program instructions for sending the at least one combined game asset to the device for use in the video game.

13. The non-transitory computer-readable medium of claim 12, wherein the program instructions for generating at least one combined game asset includes:
program instructions for identifying a texture and a plurality of decals from the plurality of game assets; and
program instructions for generating a modified texture as the at least one combined game asset by combining the texture and the plurality of decals.

14. The non-transitory computer-readable medium of claim 12, wherein the program instructions for generating at least one combined game asset includes:
program instructions for identifying a plurality of models of objects from the plurality of game assets, wherein the plurality of models of objects includes a plurality of meshes and a plurality of textures for application to the plurality of meshes; and
program instructions for generating a combined model representing the plurality of models of objects, wherein the combined model includes a combined mesh from the plurality of meshes of the plurality of models of objects, and a combined texture for application to the combined mesh.

15. The non-transitory computer-readable medium of claim 12, wherein the program instructions for generating at least one combined game asset includes:
program instructions for identifying a plurality of discrete objects from the plurality of game assets, wherein the plurality of discrete objects includes a plurality of meshes and a plurality of textures for application to the plurality of meshes;
program instructions for defining an outer shell of the plurality of discrete objects, wherein the outer shell includes a first sub-group of discrete objects taken from the plurality of discrete objects, wherein each of the discrete objects in the first sub-group of discrete objects is dynamically rendered by the video game using corresponding meshes and textures;
program instructions for defining an inner core of the plurality of discrete objects, wherein the inner core includes a second sub-group of discrete objects taken from the plurality of discrete objects,
program instructions for generating a combined mesh from meshes corresponding to the second sub-group of discrete objects, wherein the combined mesh is used to represent the inner core; and
program instructions for generating a combined texture from textures corresponding to the second sub-group of discrete objects for application to the combined mesh.

16. The non-transitory computer-readable medium of claim 12, further comprising:
program instructions for executing an instance of the video game;
program instructions for generating a scene including the plurality of game assets;
program instructions for sending each of the plurality of game assets to the optimizer server;
program instructions for receiving the at least one combined game asset;
program instructions for storing the at least one combined game asset in storage;
program instructions for accessing the at least one combined game asset from the storage; and
program instructions for rendering the scene using the at least one combined game asset to represent the plurality of game assets.

17. A computer system comprising:
a processor;
memory coupled to the processor and having stored therein instructions that, if executed by the computer system, cause the computer system to execute a method, comprising:
receiving from a device over a network at an optimizer server a plurality of game assets of a video game;
generating at least one combined game asset to represent the plurality of game assets; and
sending the at least one combined game asset to the device for use in the video game.

18. The computer system of claim 17, wherein in the method the generating at least one combined game asset includes:
identifying a texture and a plurality of decals from the plurality of game assets; and
generating a modified texture as the at least one combined game asset by combining the texture and the plurality of decals.

19. The computer system of claim 17, wherein in the method the generating at least one combined game asset includes:
identifying a plurality of models of objects from the plurality of game assets, wherein the plurality of models of objects includes a plurality of meshes and a plurality of textures for application to the plurality of meshes; and
generating a combined model representing the plurality of models of objects, wherein the combined model includes a combined mesh from the plurality of meshes of the plurality of models of objects, and a combined texture for application to the combined mesh.

20. The computer system of claim 17, wherein in the method the generating at least one combined game asset includes:
identifying a plurality of discrete objects from the plurality of game assets, wherein the plurality of discrete objects includes a plurality of meshes and a plurality of textures for application to the plurality of meshes;
defining an outer shell of the plurality of discrete objects, wherein the outer shell includes a first sub-group of discrete objects taken from the plurality of discrete objects, wherein each of the discrete objects in the first sub-group of discrete objects is dynamically rendered by the video game using corresponding meshes and textures;
defining an inner core of the plurality of discrete objects, wherein the inner core includes a second sub-group of discrete objects taken from the plurality of discrete objects,
generating a combined mesh from meshes corresponding to the second sub-group of discrete objects, wherein the combined mesh is used to represent the inner core; and
generating a combined texture from textures corresponding to the second sub-group of discrete objects for application to the combined mesh.
